(19) United States
(12) Patent Application Publication
(10) Pub. No.: US 2024/0064720 A1
(43) Pub. Date: Feb. 22, 2024

(54) SUB-BAND FULL DUPLEX RESOURCE ALLOCATION

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Ahmed Attia ABOTABL, San Diego, CA (US)

(21) Appl. No.: 18/354,408

(22) Filed: Jul. 18, 2023

Related U.S. Application Data
(60) Provisional application No. 63/399,642, filed on Aug. 19, 2022.

(51) Int. Cl. H04W 72/0453; H04L 5/14; H04W 72/0457; H04W 72/12; H04W 72/232

(52) U.S. Cl. CPC H04W 72/0453; H04L 5/14; H04W 72/0457; H04W 72/12; H04W 72/232

(57) ABSTRACT

Aspects relate to sub-band full duplex (SBFD) resource allocation. In an aspect, a network entity configures SBFD frequency resources for one or more sub-bands based on a size of the sub-bands and a size of a bandwidth part (BWP) associated with a user equipment (UE), and provides scheduling information to the UE in which the scheduling information includes a configuration of the SBFD frequency resources based on the size of the sub-bands and the size of the BWP associated with the UE. In another aspect, a UE receives scheduling information that includes a configuration of SBFD frequency resources for one or more sub-bands in which the configuration is based on a size of the sub-bands and a size of a BWP associated with the UE. The UE then communicates with a network via the SBFD frequency resources based on the scheduling information.

### CROSS-REFERENCE TO RELATED APPLICATIONS

This application claims priority to and the benefit of U.S. Provisional Patent Application No. 63/399,642, filed on Aug. 19, 2022, the entire content of which is hereby incorporated by reference.

### TECHNICAL FIELD

The technology discussed below relates generally to wireless communication and, more particularly, to sub-band full duplex (SBFD) resource allocation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

According to a first example, a user equipment (UE) is disclosed that includes a transceiver, a memory, and a processor coupled to the transceiver and the memory. The processor is configured to receive scheduling information that includes a configuration of sub-band full duplex (SBFD) frequency resources for one or more sub-bands in which the configuration is based on a size of the one or more sub-bands and a size of a bandwidth part (BWP) associated with the UE, and in which at least one of the SBFD frequency resources is not aligned with the one or more sub-bands. The processor is further configured to communicate with a network via the SBFD frequency resources based on the scheduling information.

In other examples, a method for wireless communication in a UE is disclosed. The method includes receiving scheduling information that includes a configuration of SBFD frequency resources for one or more sub-bands in which the configuration is based on a size of the one or more sub-bands and a size of a BWP associated with the UE, and in which at least one of the SBFD frequency resources is not aligned with the one or more sub-bands. The method further includes communicating with a network via the SBFD frequency resources based on the scheduling information.

Another example provides a network entity configured for wireless communication. The network entity includes a memory, and a processor coupled to the memory. The processor is configured to configure SBFD frequency resources for one or more sub-bands based on a size of the one or more sub-bands and a size of a BWP associated with a UE in which at least one of the SBFD frequency resources is not aligned with the one or more sub-bands. The processor is further configured to provide scheduling information to the UE in which the scheduling information includes a configuration of the SBFD frequency resources based on the size of the one or more sub-bands and the size of the BWP associated with the UE.

According to yet another example, a method for wireless communications in a network entity is disclosed. The method includes configuring SBFD frequency resources for one or more sub-bands based on a size of the one or more sub-bands and a size of a BWP associated with a UE in which at least one of the SBFD frequency resources is not aligned with the one or more sub-bands, and further includes providing scheduling information to the UE in which the scheduling information includes a configuration of the SBFD frequency resources based on the size of the one or more sub-bands and the size of the BWP associated with the UE.

These and other aspects of the disclosure will become more fully understood upon a review of the detailed description, which follows. Other aspects, features, and examples of the present disclosure will become apparent to those of ordinary skill in the art, upon reviewing the following description of specific examples of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while examples may be discussed below as device, system, or method examples it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIGS. 5A-5C illustrate examples of full-duplex communication in an unpaired spectrum.

FIG. 6A a schematic diagram of a network entity configured for full-duplex communication according to some aspects.

FIG. 6B is schematic illustration of an exemplary sub-band full-duplex wireless communication using the multi-panel antenna array shown in FIG. 6A according to some aspects.

FIG. 7 illustrates an exemplary sub-band full duplex (SBFD) resource allocation without partial resource block groups (RBGs).

FIG. 8 illustrates an exemplary SBFD resource allocation with partial RBGs according to some aspects.

FIG. 9 illustrates a first exemplary effective downlink (DL) sub-band according to some aspects.

FIG. 10 illustrates a second exemplary effective DL sub-band according to some aspects.

FIG. 11 illustrates a first exemplary effective uplink (UL) sub-band according to some aspects.

FIG. 12 illustrates a second exemplary effective UL sub-band according to some aspects.

FIG. 13 illustrates an exemplary effective UL sub-band and an exemplary effective DL sub-band according to some aspects.

FIG. 14 illustrates an exemplary SBFD resource allocation according to some aspects.

FIG. 15 is a block diagram illustrating an example of a hardware implementation for a user equipment (UE) employing a processing system according to some aspects.

FIG. 16 is a flow chart illustrating an example of a method for communication in a UE according to some aspects.

FIG. 17 is a block diagram illustrating an example of a hardware implementation for a network entity such as a base station employing a processing system according to some aspects.

FIG. 18 is a flow chart illustrating a method for communication in a network entity according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

Aspects disclosed herein are directed towards enhancements of resource allocation in symbols with sub-bands that a network would use for sub-band full duplex (SBFD) operation. In a particular aspect, a network entity (e.g., a gNB) schedules SBFD resources for a sub-band based on a size of the sub-band. In some examples, such scheduling desirably facilitates the utilization of partial resource block groups (RBGs) and partial precoding resource groups (PRGs) during SBFD operation. In further examples, such scheduling also desirably facilitates the utilization of a frequency domain resource assignment (FDRA) bit width of finer granularity during SBFD operation while keeping the same DCI overhead as a TDD slot or reduce the DCI overhead in SBFD slot while keeping the same scheduling granularity as in a TDD slot.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, examples and/or uses may come about via integrated chip examples and other non-module-component based devices (e.g., end-user devices, vehicles, communication devices, computing devices, industrial equipment, retail/purchasing devices, medical devices, artificial intelligence-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

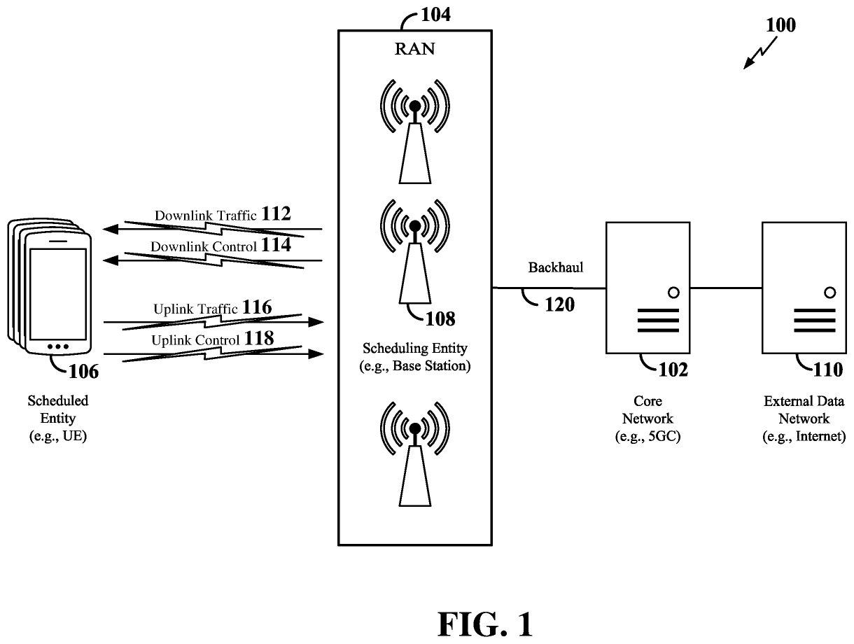

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station. In addition, one or more of the base stations may have a disaggregated configuration.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

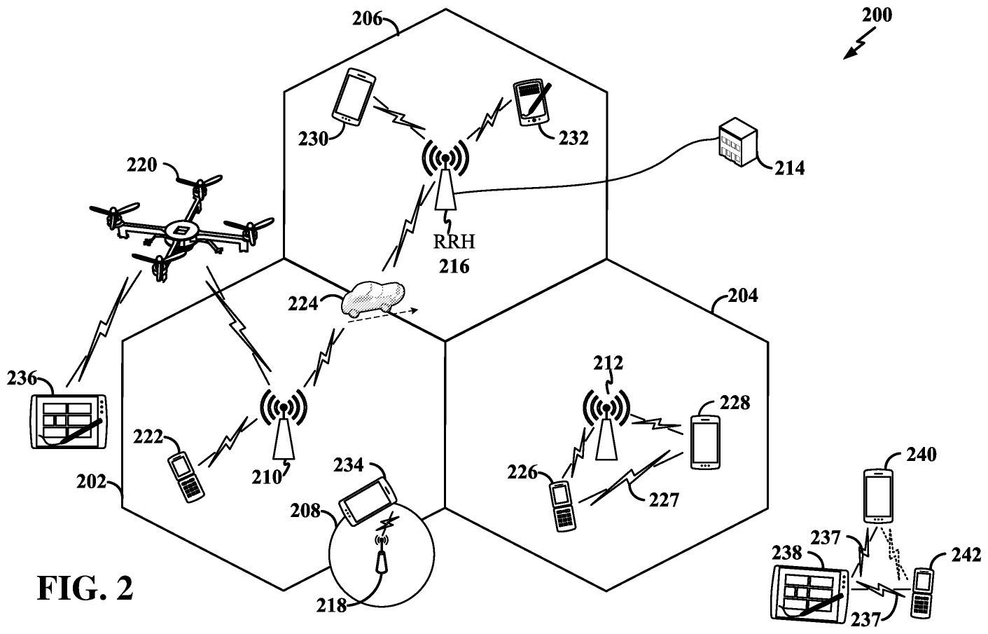

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

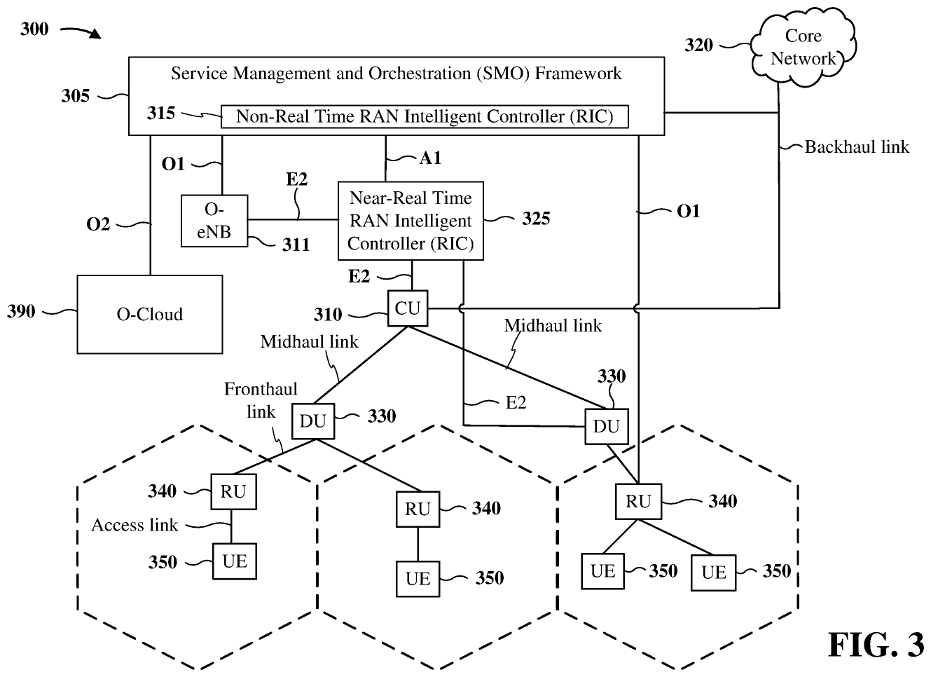

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as AI policies).

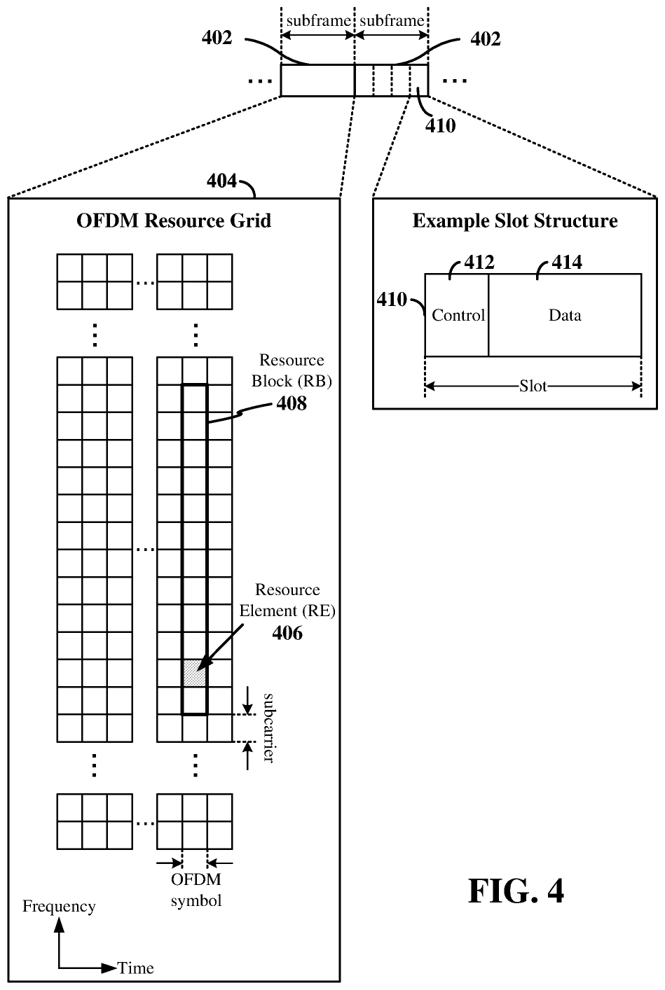

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

A transport block may be communicated between a scheduling entity (e.g., base station, such as a gNB) and a scheduled entity (e.g., a UE) over downlink resources or uplink resources allocated in a slot for the transport block. When operating in a full-duplex mode, both downlink and uplink resources may be allocated within symbols of the same slot for the transmission of both a downlink transport block and an uplink transport block, respectively. In some examples, the downlink and uplink resources may overlap in time (e.g., one or more symbols of the slot may carry both the downlink transport block and the uplink transport block). For example, simultaneous transmissions in different directions (uplink and downlink) may utilize frequency division duplex (FDD) in paired spectrum (e.g., the transmissions in different directions are carried on different carrier frequencies) or in unpaired spectrum (e.g., the transmissions in different directions are carried on a single carrier bandwidth).

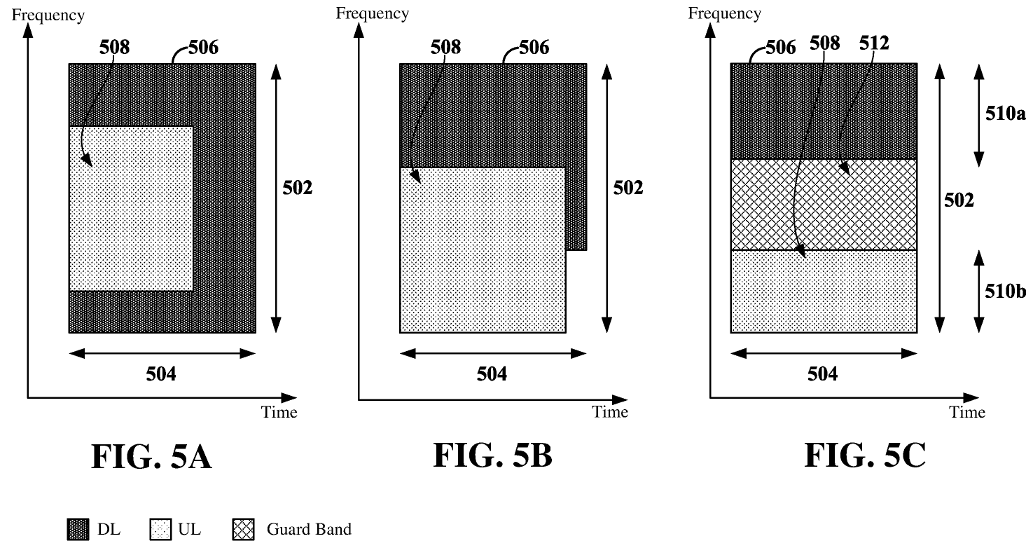

FIGS. 5A-5C illustrate examples of full-duplex communication in an unpaired spectrum. In the examples shown in FIGS. 5A-5C, time is in the horizontal direction and frequency is in the vertical direction. Here, a carrier bandwidth 502 (or set of one or more active bandwidth parts (BWPs)) is illustrated along the frequency axis and a slot 504 is illustrated along the time axis.

FIGS. 5A and 5B illustrate in-band full-duplex (IBFD) communication, while FIG. 5C illustrates sub-band FDD communication. For IBFD communication, as shown in FIGS. 5A and 5B, downlink and uplink transmissions occur on the same time and frequency resources. For example, downlink resources 506 allocated for transmissions in the downlink direction overlap in both time and frequency with uplink resources 508 allocated for transmissions in the uplink direction. The overlap may be full (as shown in FIG. 5A) or partial (as shown in FIG. 5B).

For sub-band FDD communication, as shown in FIG. 5C, the carrier bandwidth 502 (or active BWPs) may be divided into sub-bands 510a and 510b. Each sub-band 510a and 510b may be allocated for communication in a single direction. For example, sub-band 510a may be allocated for downlink transmissions, while sub-band 510b may be allocated for uplink transmissions. Thus, downlink resources 506 allocated for transmissions in the downlink direction overlap in time, but not in frequency, with uplink resources 508 allocated for transmissions in the uplink direction. The downlink resources 506 may further be separated from the uplink resources 508 in the frequency domain by a guard band 512 to isolate the uplink and downlink transmissions in frequency.

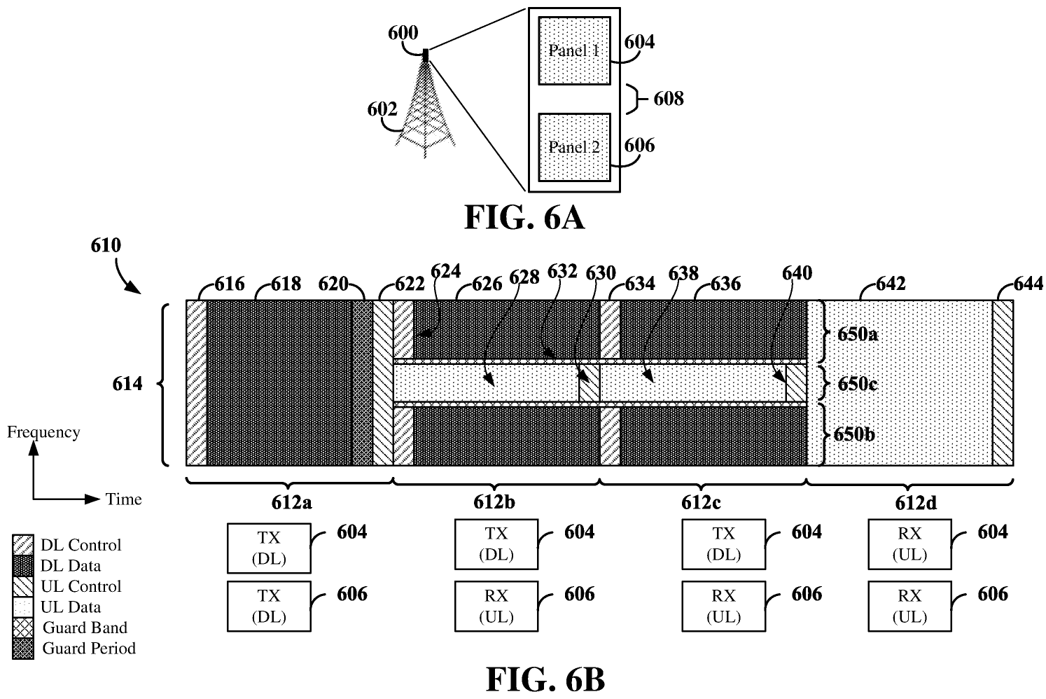

FIG. 6A is a schematic diagram of a network entity 602 (e.g., as shown in any of FIGS. 1-3) including an antenna array 600 configured for full-duplex communication according to some aspects. The antenna array 600 is divided into two panels (panel 1 604, panel 2 606) with a physical separation 608 therebetween. Each of the two panels may be a subarray of antennas. A given panel may transmit and/or receive a beam or a beam group. In one example, the panels may be physically separated from one another by a distance selected to provide improved isolation between simultaneous transmission (Tx) and reception (Rx) operations in full-duplex mode, thereby mitigating at least a portion of self-interference resulting from signals being simultaneously transmitted/received. The multi-panel antenna configuration shown in FIG. 6A may also be applicable to UEs to enable full-duplex communication at the UE.

FIG. 6B is schematic illustration of an example of sub-band full-duplex wireless communication 610 using the multi-panel antenna array 600 shown in FIG. 6A according to some aspects. In the example shown in FIG. 6B, time is in the horizontal direction with units of slots 612a-612d, each including a plurality of OFDM symbols; and frequency is in the vertical direction. Here, a carrier bandwidth 614 (or set of one or more active BWPs) is illustrated along the frequency axis. The carrier bandwidth 614 (or active BWPs) may be divided into a number of sub-bands 650a-650c for sub-band FDD full-duplex operation.

In the example shown in FIG. 6B, in slot 612a, the antenna array 600 is first configured for downlink (DL) communication (e.g., DL burst 616 and DL data portion 618). The DL burst 616 may include DL control transmitted within the first few symbols of the slot 612a. The DL control 616 may include, for example, a physical downlink control channel (PDCCH) carrying DCI that may be related to the slot 612a or a previous or subsequent slot. In an example, the DCI may include common DCI or UE-specific DCI. The common DCI may include, for example, common control information broadcast to a group of UEs or all UEs in the cell. The UE-specific DCI may include, for example, HARQ feedback information (e.g., ACK/NACK), scheduling information for scheduling a downlink data transmission and/or uplink transmission in the slot 612a or a subsequent slot (e.g., slot 612b, 612c, and/or 612d), and other suitable information. The DL burst 616 may further include various DL reference signals (e.g., SSB and/or CSI-RS). In this example, both panel 1 604 and panel 2 606 may be configured for DL transmission. The DL data portion 618 may include DL data carried within, for example, a PDSCH. In addition to the DL data, the DL data portion 618 may further include DL reference signals (e.g., DMRS) for use in demodulating and decoding the DL data.

Slot 612a may also include a common uplink (UL) burst 622 at the end of slot 612a. The common UL burst 622 may include, for example, a PUCCH carrying UCI and other UL signals. As illustrated in FIG. 6B, the end of the DL data portion 618 may be separated in time from the beginning of the UL burst 622. This time separation 620 may sometimes be referred to as a gap, a guard period, a guard interval, and/or various other suitable terms. This separation may provide time for the network entity and UE to perform a switch-over between transmitting and receiving, or vice-versa. In this example, both panel 1 604 and panel 2 606 may be configured for UL transmission during the UL burst 622.

In slots 612b and 612c, the antenna array 600 is configured for both DL communication and UL communication. For example, in slots 612b and 612c, the carrier bandwidth 614 (or active BWPs) is shown partitioned between uplink transmissions and downlink transmissions. Sub-bands 650a and 650b are allocated for downlink transmissions, while sub-band 650c is allocated for uplink transmissions. In an example operation of the sub-band full-duplex configuration shown in FIG. 6, panel 1 604 may be configured for DL transmission at both edges (e.g., sub-bands 650a and 650b) of the carrier bandwidth 614 (or active BWPs) and panel 2 606 may be configured for UL reception in the middle (e.g., sub-band 650c) of the carrier bandwidth 614 (or active BWPs).

In each of the sub-band FDD slots 612b and 612c, the DL sub-bands 650a and 650b include a DL burst 624 and 634, respectively, which may include a PDCCH carrying DCI and/or DL reference signals, in the initial portion of the slots 612b and 612c. Following the DL bursts 624 and 634, slots 612b and 612c each include a DL data portion 626 and 636, respectively, for transmitting DL data within sub-bands 650a and 650b. For example, the DL data may be transmitted within a PDSCH. In addition to the DL data, the DL data portions 626 and 636 may further include DL reference signals (e.g., DMRS) for use in demodulating and decoding the DL data.

In the uplink (UL) sub-band 650c, the slots 612b and 612c each include an UL data portion 628 and 638, respectively, for transmitting UL data. For example, the UL data may be transmitted within a PUSCH. Following the UL data portions 628 and 638, the UL sub-band 650c of slots 612b and 612c each include an UL burst 630 and 640, respectively. The UL burst 630 and 640 may include, for example, a PUCCH including UCI and/or other UL signals. Guard bands 632 are further provided between the UL sub-band 650c and the DL sub-bands 650a and 650b to mitigate self-interference between simultaneous DL transmissions in the DL sub-bands 650a and 650b and UL transmissions in the UL sub-band 650c.

Slots 612b and 612c are sub-band full-duplex FDD slots utilizing FDM for multiplexing uplink and downlink transmissions in frequency. The sub-band full-duplex slot configurations shown in FIG. 6 are merely exemplary, and other configurations of sub-band full-duplex slots may be utilized in various aspects of the disclosure. For example, sub-band full-duplex slots including other configurations of UL and DL sub-bands (e.g., the configuration shown in FIG. 4C or other suitable sub-band configurations) may be employed in various aspects.

In slot 612d, the antenna array 600 is configured for UL communication. For example, slot 612d includes an UL data portion 642 followed by an UL burst 644. The UL data portion 642 and UL burst 644 may include UL control information and/or UL data, as discussed above. In this example, both panel 1 604 and panel 2 606 may be configured for UL reception. Slots 612a and 612d are half-duplex TDD slots utilizing TDM for multiplexing DL transmissions and UL transmissions in time.

With respect to frequency-domain resource allocation (FDRA), it should be noted that FDRA in NR is similar to FDRA in LTE, except that NR frequency resources are allocated per BWP, whereas LTE frequency resources are allocated over an entire carrier bandwidth. It should be further noted that NR supports two types of resource allocation schemes (Type 0 or Type 1) in which the particular resource allocation type is determined either implicitly by the DCI format or by an RRC layer message.

In a Type 0 resource allocation, a bitmap-based resource allocation scheme is used in which the RB assignment information includes a bitmap indicating the resource block groups (RBGs) that are allocated to the scheduled UE, where resources are allocated in multiples of RBGs. The number of RBs within an RBG varies depending on BWP size and configuration type, as shown in Table 1 below, where the configuration type is determined by the rbg-size field in PDSCH-Config included in an RRC message.

TABLE 1

| Bandwidth part size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In a Type 1 resource allocation, only a contiguous allocation of virtual resource blocks (VRBs) is supported. Here, the network provides the UE with an encoded resource indicator value (RIV), which corresponds to a starting virtual resource block number RBₛₜₐᵣₜ and a length in terms of contiguously allocated VRBs (L_{RBs}). For instance, RIV may be calculated according to the equation below:

$$if ( {L}_{RBs} - 1 ) \leq ⌊ \frac{{N}_{BWP}^{size}}{2} ⌋ then \qquad ( Equation 1 )$$

$$RIV = {N}_{BWP}^{size} ( {L}_{RBs} - 1 ) + {RB}_{start} else$$

$$RIV = {N}_{BWP}^{size} ( {N}_{BWP}^{size} - {L}_{RBs} + 1 ) + ( {N}_{BWP}^{size} - 1 - {RB}_{start} )$$

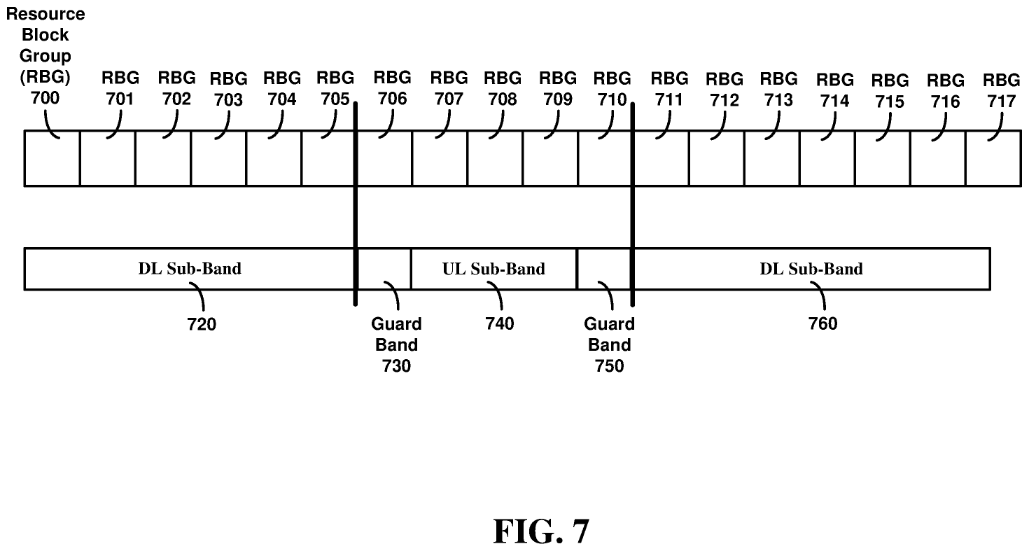

Referring next to FIG. 7, an exemplary sub-band full duplex (SBFD) resource allocation without partial resource block groups (RBGs) is shown. For this example, each of DL sub-band 720, guard band 730, UL sub-band 740, guard band 750, and DL sub-band 760, are aligned with RBGs 700-717, as shown. Here, for Type 0 resource allocation across the two DL sub-bands 720 and 760, the frequency resources mapped to UL sub-band 740 and guard bands 730 and 750 are not used for allocation. This may yield various problems, however. For instance, there may be limited configurations of DL/UL sub-bands to accommodate the resolutions of the RBGs (each including 2, 4, 8, or 16 RBs) to align RBGs 700-717 with the sub-band sizes of UL sub-band 740 and guard bands 730 and 750. This issue is even more pronounced for large DL bandwidth parts (BWP) (e.g., where BWP>145 RBs and the RBG size is 16 RBs). Additionally, when a DL sub-band is not aligned with the RBGs, this results in limited scheduling flexibility where the RBGs at the edges of the DL sub-bands cannot be used.

In an example, to facilitate more flexibility in the scheduling of UL and DL sub-bands while keeping the same DCI overhead, an SBFD-aware UE can be configured to allow partial RBGs at the edges of the DL sub-bands. For instance, the first and last RBG in each sub-band can be a partial RBG, whereby the network (e.g., a gNB) can provide the UE with a bitmap indicating that the corresponding PRBs within the partial RBGs are utilized for DL or UL communication. This enhancement could be based, for example, on a UE's capability to support partial RBGs in SBFD communications.

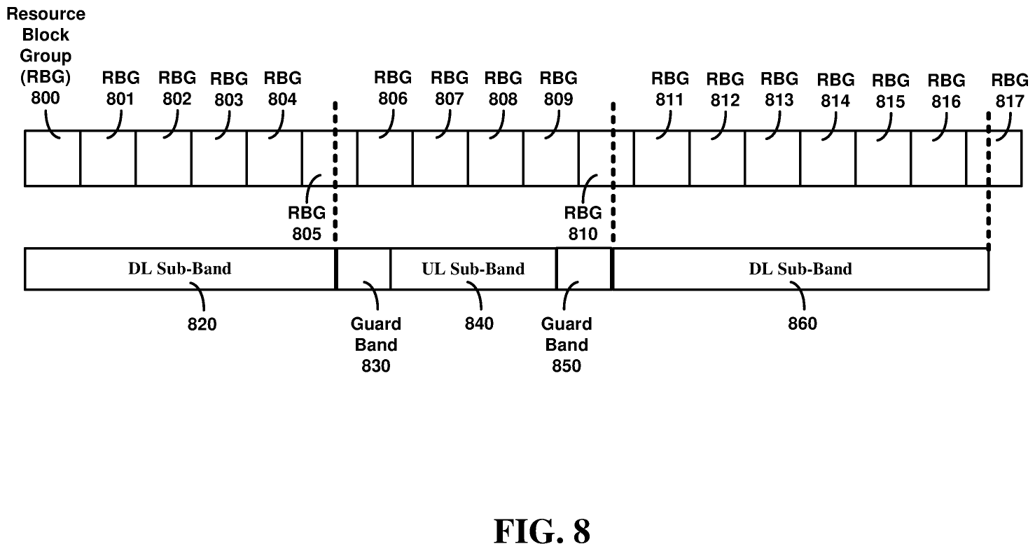

Referring next to FIG. 8, an exemplary SBFD resource allocation with partial RBGs is provided according to some aspects. For this example, each of DL sub-band 820, guard band 830, UL sub-band 840, guard band 850, and DL sub-band 860, are aligned with RBGs 800-817, as shown. Here, it is assumed that the RBG size is 16 RBs, where the size of DL sub-band 820 is 90 RBs and the size of DL sub-band 860 is 106 RBs. As shown, DL sub-band 820 uses only some of the RBs of RBG 805 (i.e., 10 of the 16 RBs), whereas DL sub-band 860 uses only some of the RBs of RBG 810 (i.e., 7 of the 16 RBs) and some of the RBs of RBG 817 (i.e., 3 of the 16 RBs). To accommodate such partial RBGs, SBFD scheduling of RBGs may be based on a size of DL sub-band 820 and/or DL sub-band 860, rather than a size of a corresponding DL bandwidth part (BWP).

In a particular example, the total number of RBGs (N_{RBG}) for a downlink sub-band i of size N_{SB,i}^{size} PRBs is given by:

N_{RBG}=┌(N_{SB,i}^{size}+(N_{SB,i}^{start} mod P))/P┐ (Equation 2)

where
the size of the first RBG in the sub-band is RBG₀^{size}=P−N_{SB,i}^{start} mod P,
the size of last RBG in the sub-band is RBGₗₐₛₜ^{size}=(N_{SB,i}^{start}+N_{SB,is}^{ize}) mod P if (N_{SB,i}^{start}+N_{SB,i}^{size}) mod P>0 and P otherwise, and
the size of all other RBGs is P.

In the case where the network schedules a DL transmission (or UL transmission) across more than one DL (or UL sub-band), then the total number of RBGs (N_{RBG}) for a downlink sub-band i and sub-band j of size N_{SB,i}^{size} and N_{SB,j}^{size} PRBs respectively is given by:

N_{RBG}=┌(N_{SB,i}^{size}+(N_{SB,i}^{start} mod P))/P┐+┘(N_{SB,j}^{size}+(N_{SB,j}^{start} mod P))/P┐ (Equation 3)

where
the size of the first RBG in sub-band i is RBG_{0,1}^{size}=P−N_{SB,i}^{start} mod P,
the size of the first RBG in sub-band j is RBG_{0,j}^{size}=P−N_{SB,j}^{start} mod P,
the size of the last RBG in sub-band i is RBG_{last,i}^{size}=(N_{SB,i}^{start}+N_{SB,i}^{size}) mod P if (N_{SB,i}^{start}+N_{SB,i}^{size}) mod P>0 and P otherwise, the size of all other RBGs is P, and
the size of the last RBG in sub-band j is RBG_{last,j}^{size}=(N_{SB,j}^{start}+N_{SB,j}^{size}) mod P if (N_{SB,j}^{start}+NSB_{SB,j}^{size}) mod P>0 and P otherwise, the size of all other RBGs is P.

In another exemplary solution disclosed herein, a new table of RBG size with higher resolution (i.e. smaller RBG size) is introduced specifically for the SBFD slot. For instance, Table 2 below may be used for SBFD slots, whereas Table 1 may be used for non-SBFD slots.

TABLE 2

| Bandwidth part size | Configuration 1 | Configuration 2 |
|---|---|---|
| 1-36 | 2 | 2 |
| 37-72 | 2 | 4 |
| 73-144 | 4 | 8 |
| 145-275 | 8 | 8 |

Alternatively, rather than utilizing multiple tables, Table 1 may be revised to include additional columns specifically for SBFD slots. For instance, Table 1 may be revised to include a third configuration, as illustrated in Table 3 below, where Configuration 3 is used for scheduling SBFD slots, whereas Configurations 1 and 2 are used for scheduling non-SBFD slots.

TABLE 3

| Bandwidth part size | Configuration 1 | Configuration 2 | Configuration 3 |
|---|---|---|---|
| 1-36 | 2 | 4 | 1 |
| 37-72 | 4 | 8 | 2 |
| 73-144 | 8 | 16 | 4 |
| 145-275 | 16 | 16 | 8 |

Similarly, partial PRGs may be utilized as well, Where the sizes of the first and last PRGs of a sub-band are not necessarily equal to each other or other PRGs within the sub-band. By way of background, it is noted that the precoding granularity P_{BWP,i}′ for a non-SBFD slot is typically defined as either 2 RBs or 4 RBs, where it is understood that PRGs partition a bandwidth part i with P_{BWP,i}′ consecutive PRBs, and where the actual number of consecutive PRBs in each PRG could be one or more. Moreover, when determining the size of the first and last PRGs of a non-SBFD slot, it should be noted that such sizes are typically based on a starting RB of the bandwidth part i (N_{BWP,i}^{start}) and a length of the bandwidth part i (N_{BWP,i}^{size}). For instance, the sizes of the first and last PRGs of a non-SBFD slot may be determined as follows:

First PRG size=P_{BWP,i}′−N_{BWP,i}^{start} mod P_{BWP,i}′; and

Last PRG size=(N_{BWP,i}^{start}+N_{BWP,i}^{size})mod P_{BWP,i}′ if (N_{BWP,i}^{start}+N_{BWP,i}^{size})mod P_{BWP,i}′≠0, otherwise the last PRG is given by P_{BWP,i}′. (Equation 4)

With SBFD slots, however, such method for determining PRG size is undesirable since the sizes of the first and last PRGs within each scheduled sub-band are not necessarily equal to the indicated P_{BWP,i}′. To overcome this limitation, aspects disclosed herein include examples where the sizes of the first and last PRGs within each scheduled sub-band are based on the effective available resources of each sub-band, which is hereby defined as the overlap of the particular sub-band and a corresponding BWP portion of a UE. In a particular example, the sizes of the first and last PRGs within each scheduled sub-band may thus be based on a starting RB of the effective sub-band (N_{SB}^{start}) and a length of the effective sub-band (N_{,SB}^{size}), rather than a starting RB of the bandwidth part I (N_{BWP,i}^{start}) and a length of the bandwidth part i (N_{BWP,i}^{size}). For instance, the size of the first and last PRGs of an SBFD slot may be determined as follows:

First PRG size=P_{BWP,i}′−N_{SB}^{start} mod P_{BWP,i}′; and

Last PRG size=(N_{SB}^{start}+N_{,SB}^{size})mod P_{BWP,i}′ if (N_{SB}^{start}+N_{,SB}^{size})mod P_{BWP,i}′≠0, otherwise the last PRG is given by P_{BWP,i}′. (Equation 5)

Referring back to the example described with reference to FIG. 8, an exemplary calculation of PRG size for the first and last PRGs for each of DL sub-band 820 and DL sub-band 860 is now provided. Here, it is again assumed that the RBG size is 16 RBs, where the size of DL sub-band 820 is 90 RBs and the size of DL sub-band 860 is 106 RBs. With respect to calculating the PRG size of the first and last PRGs of DL sub-band 820, it is thus noted that P_{BWP,i}′=4, N_{SB}^{start}=0, and N_{SB}^{size}=90, which yields a first PRG size of 4 RBs and a last PRG size of 2 RBs. With respect to calculating the PRG size of the first and last PRGs of DL sub-band 860, it is noted that P_{BWP,i}′=4, N_{SB}^{start}=164, and N_{,SB}^{size}=106, which yields a first PRG size of 4 RBs and a last PRG size of 2 RBs.

In a further example, it should be noted that the PRG size for each sub-band within a UE BWP could be further optimized. For instance, for static bundling (i.e., where prb-BundlingType is set to ‘staticBundling’), a gNB may configure the RRC parameter ‘bundleSize’ to indicate a set of PRG size values {P_{BWP,i}′, P_{SB}_{₁}_{,i}′,P_{SB}_{₂}_{,i}′} where the value for P_{BWP,i}′ maps to the PRG size in the TDD slot, and where the values for P_{SB}_{₁}_{,i}′ and P_{SB}_{₂}_{,i}′ map to the respective PRG sizes for each sub-band.

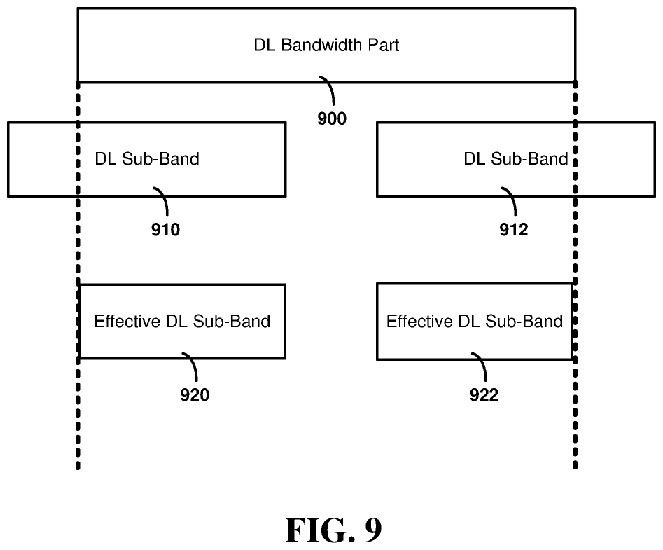

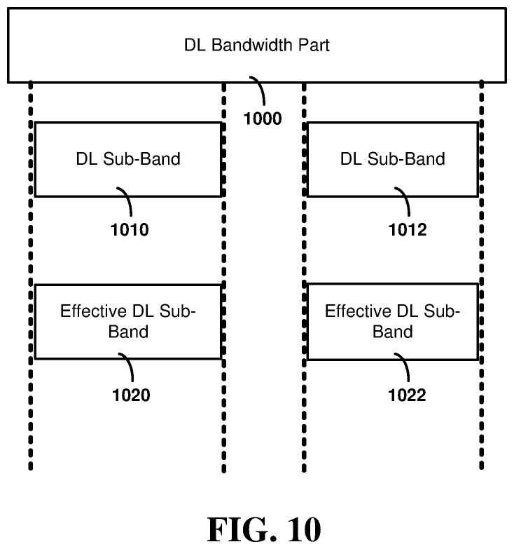

Referring next to FIGS. 9-13, various illustrations of exemplary effective DL/UL sub-bands are provided according to some aspects. For instance, FIG. 9 illustrates a first example in which a first effective DL sub-band 920 is ascertained by the overlap of DL sub-band 910 and a corresponding DL BWP 900, and where a second effective DL sub-band 922 is ascertained by the overlap of DL sub-band 912 and the corresponding DL BWP 900. In FIG. 10, an example is provided where each of DL sub-bands 1010 and 1012 entirely overlap with DL BWP 1000, which yield effective DL sub-bands 1020 and 1022, as shown.

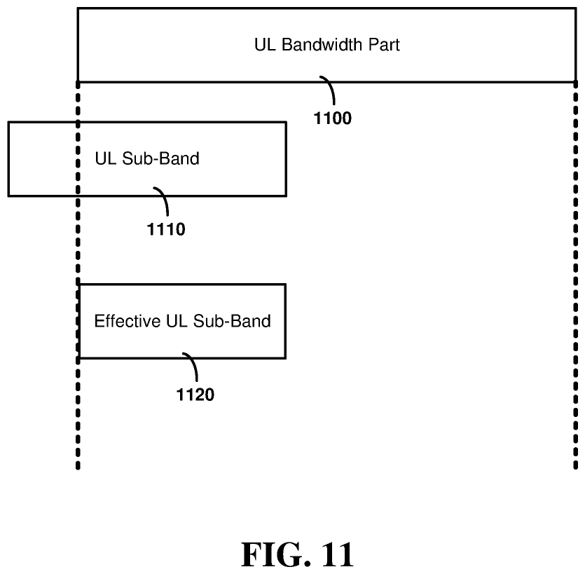

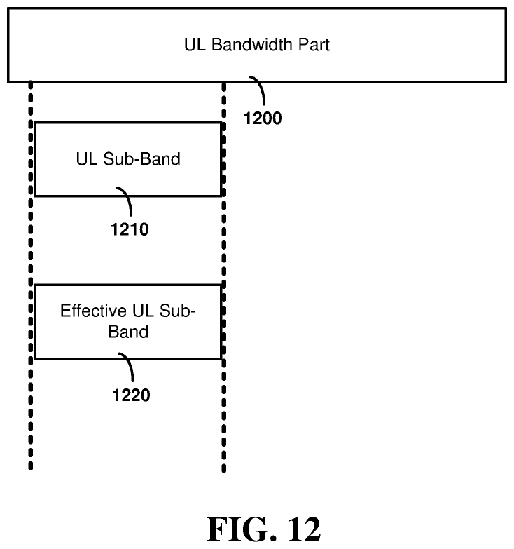

In FIGS. 11 and 12, examples are provided of effective UL sub-bands in accordance with some aspects. For instance, FIG. 11 illustrates a first example in which effective UL sub-band 1120 is ascertained by the overlap of UL sub-band 1110 and a corresponding UL BWP 1100. In FIG. 12, an example is provided where UL sub-band 1210 entirely overlaps with UL BWP 1200, which yield effective UL sub-band 1220, as shown.

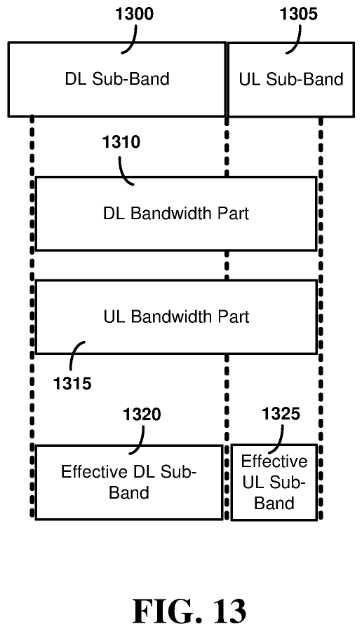

FIG. 13 illustrates an exemplary effective UL sub-band and an exemplary effective DL sub-band according to some aspects. In this example, the UE is configured with DL/UL BWP pairs 1310 and 1315 that have the same center frequency, and where the configurations of DL sub-band 1300 and UL sub-band 1305 are provided by the gNB. As illustrated, the effective DL sub-band 1320 is based on the available frequency resources overlapping between the DL-sub-band 1300 and the active DL-BWP 1310. Similarly, the effective UL sub-band 1325 is based on the available frequency resource overlapping between the UL sub-band 1305 and the active UL BWP 1315.

In further examples, the SBFD scheduling aspects disclosed herein also desirably facilitate the utilization of a frequency domain resource assignment (FDRA) bit width of finer granularity during SBFD operation while either keeping the same DCI overhead as a corresponding TDD slot, or reducing the DCI overhead in the SBFD slot while keeping the same scheduling granularity in the TDD slot. For instance, with reference to the example provided for FIG. 8 where it is assumed that the size of DL sub-band 820 is 90 RBs and the size of DL sub-band 860 is 106 RBs, it shall be further assumed that the size of UL sub-band 840 is 62 RBs, and that each of guard band 830 and guard band 850 are 6 RBs. For this particular SBFD configuration, the size of the UL/DL BWP is thus 270 RBs, which includes two DL sub-bands (i.e., DL sub-bands 820 and 860) and one UL sub-band (i.e., UL sub-band 840). With respect to a Type 0 resource allocation, Table 1 may then be referenced to determine the nominal RBG size P for each of the BWP, DL sub-bands 820 and 860, and UL sub-band 840. For example, assuming that parameter rbg-size is 18 bits, the nominal RBG size P of the BWP is 16 RBs for both Configuration 1 and 2, since the size of the BWP is 270 RBs. For DL sub-bands 820 and 860, assuming that parameter rbg-size is 18 bits (i.e., Configuration 1), the nominal RBG size P is 8 RBs for each of DL sub-bands 820 and 860 (i.e., since their respective lengths are 90 RBs and 106 RBs), whereas a parameter rbg-size value of 9 bits (i.e., Configuration 2) yields a nominal RBG size P of 16 RBs for each of DL sub-bands 820 and 860. With respect to UL sub-band 840, assuming that parameter rbg-size is 18 bits (i.e., Configuration 1), the nominal RBG size P is 4 RBs (i.e., since the length of UL sub-band 840 is 62 RBs), whereas a parameter rbg-size value of 9 bits (i.e., Configuration 2) yields a nominal RBG size P of 8 RBs. From these examples, it should thus be noted that Configuration 1 allows for better resolution while Configuration 2 enables DCI compression by half and possibly better resolution, as shown by the UL sub-band 840 example.

In some aspects disclosed herein, when a gNB schedules PxSCH in one sub-band, the FDRA bitfield in the DCI may be interpreted based on the sub-band size, rather than the BWP size. For instance, for a Type 0 resource allocation, a UE may utilize a new table, such as Table 4 below, to determine nominal RBG sizes based on an indicated sub-band size.

TABLE 4

| Indicated Sub-band Size | Configuration 1 | Configuration 2 |
|---|---|---|
| 1-36 | 2 | 2 |
| 37-72 | 2 | 4 |
| 73-144 | 4 | 8 |
| 145-275 | 8 | 8 |

In further aspects disclosed herein, Type 1 resource allocation (i.e., RIV-based resource allocation) may also be based on sub-band size. For instance, the start RB and number of VRBs may be based on the sub-band size, as indicated by the following:

$$( {L}_{RBs} - 1 ) \leq ⌊ \frac{{N}_{subband}^{size}}{2} ⌋ then \qquad ( Equation 6 )$$

$$RIV = {N}_{SB}^{size} ( {L}_{RBs} - 1 ) + {RB}_{start} else$$

$$RIV = {N}_{SB}^{size} ( {N}_{SB}^{size} - {L}_{RBs} + 1 ) + ( {N}_{SB}^{size} - 1 - {RB}_{start} )$$

$$where {RB}_{start} is the first RB in the scheduled sub - band ;$$

$$where {L}_{RBs} \geq 1 ; and$$

$$where {RB}_{start} shall not exceed {L}_{RBs} .$$

In other aspects disclosed herein, where FDRA is still based on BWP size, two DCI bitfields could be added to improve scheduling flexibility. For instance, the DCI may include a bitfield for indicating one or more of the sub-bands for scheduling. When there are two sub-bands, for example, the ‘subband-indicator’ bitfield may be two bits, where an indicated value of ‘10’ may indicate a scheduling in a first sub-band; an indicated value of ‘01’ may indicate a scheduling in a second sub-band; and an indicated value of ‘11’ may indicate a scheduling in both sub-bands.

Also, to improve flexibility, dynamic switching between Configuration 1 and Configuration could be indicated by the DCI bitfield. Values for ‘subband-indicator’ and ‘RBG-configuration-indicator’ could be included in new DCI bitfields, for example, or jointly encoded with the FRDA bitfield (e.g., by utilizing an unused bitfield for the other sub-band or by utilizing the least significant bit (LSB) or most significant bit (MSB)).

In another example, when a gNB schedules in two or more sub-bands, the FRDA bitfield may be based on effective available frequency resources in the SBFD slots. For Type 1 resource allocation, for example, N_{RB}^{DL,BWP} may refer to the number of available RBs in the DL BWP, excluding the guard band RBs and the UL sub-band RBs, or equal to the N_{RB}^{DL,Subband(s)}, which is the number of combined DL RBs across the effective DL sub-band(s). Meanwhile, the N_{RB}^{UL,BWP} may refer to the number of available RBs in the UL BWP, excluding the guard band RBs and the DL sub-band RBs, or equal to the N_{RB}^{UL,Subbands(s)}, which is the number of combined UL RBs across the effective UL sub-band(s).

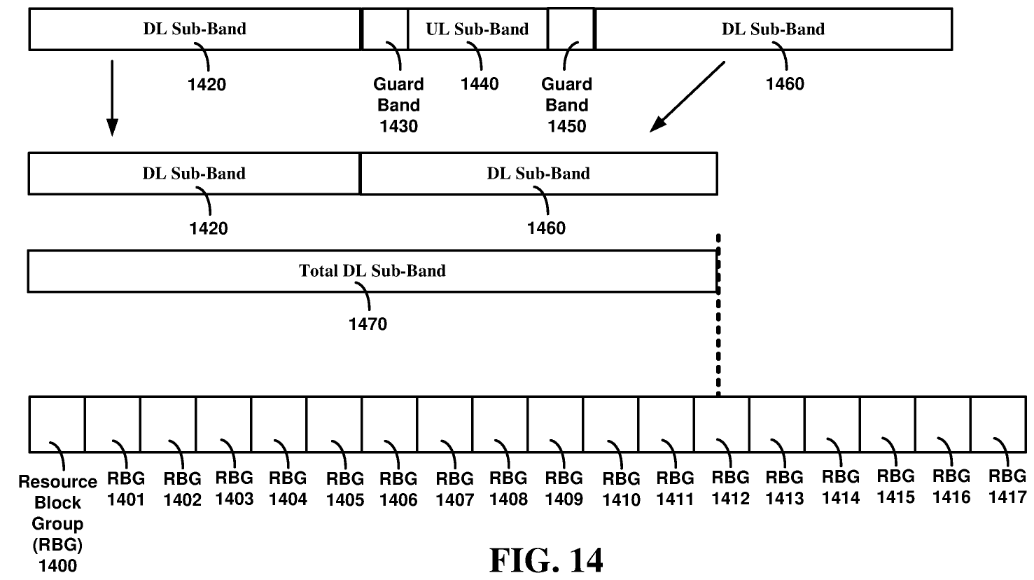

For Type 0 resource allocation, the N_{BWP,i}^{size} may refer to the size of the combined effective DL (or UL) sub-bands in the DL (or UL) BWP as shown in FIG. 14. As illustrated, for this particular example, each of DL sub-band 1420, guard band 1430, UL sub-band 1440, guard band 1450, and DL sub-band 1460, are aligned with RBGs 1400-1417. Here, it is assumed that the RBG size is 16 RBs and that the BWP is 272 RBs, where the size of DL sub-band 1420 is 90 RBs and the size of DL sub-band 1460 is 106 RBs. The size of the total DL sub-band 1470 is thus 196 RBs, where the total DL sub-band 1470 only uses some of RBG 1412 (i.e., only 4 of the 16 RBs).

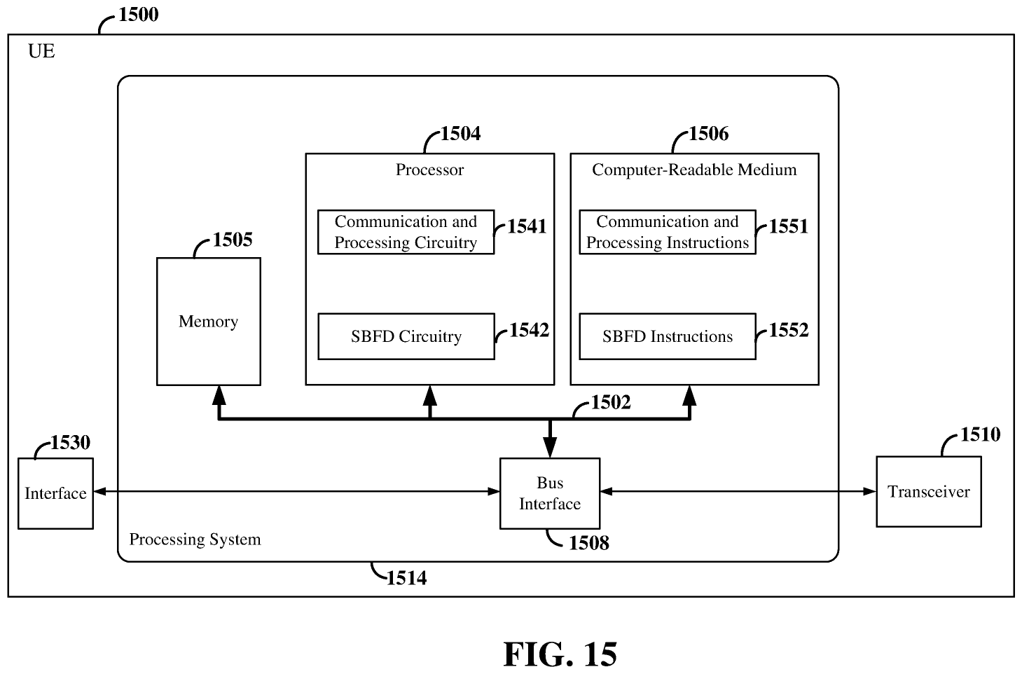

FIG. 15 is a block diagram conceptually illustrating an example of a hardware implementation for a user equipment (UE) 1500 employing a processing system 1514 according to some aspects of the disclosure. In accordance with various aspects of the disclosure, an element, or any portion of an element, or any combination of elements may be implemented with a processing system 1514 that includes one or more processors 1504. In some implementations, the UE 1500 may correspond to any of the UEs or scheduled entities shown in any of the FIGs. included herein.

The UE 1500 may be implemented with a processing system 1514 that includes one or more processors 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1500 may be configured to perform any one or more of the functions described herein. That is, the processor 1504, as utilized in a UE 1500, may be used to implement any one or more of the processes and procedures described below.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits including one or more processors (represented generally by the processor 1504), a memory 1505, and computer-readable media (represented generally by the computer-readable medium 1506). The bus 1502 may also link various other circuits such as timing sources, peripherals, voltage regulators, and power management circuits, which are well known in the art, and therefore, will not be described any further. A bus interface 1508 provides an interface between the bus 1502 and a transceiver 1510 and between the bus 1502 and an interface 1530. The transceiver 1510 provides a communication interface or means for communicating with various other apparatus over a wireless transmission medium. In some examples, the wireless communication device may include two or more transceivers 1510, each configured to communicate with a respective network type (e.g., terrestrial or non-terrestrial). At least one interface 1530 (e.g., a network interface and/or a user interface) provides a communication interface or means of communicating with various other apparatus and devices (e.g., other devices housed within the same apparatus as the UE 1500 or an external apparatus) over an internal bus or via external transmission medium, such as an Ethernet cable.

The processor 1504 is responsible for managing the bus 1502 and general processing, including the execution of software stored on the computer-readable medium 1506. The software, when executed by the processor 1504, causes the processing system 1514 to perform the various functions described below for any particular apparatus. The computer-readable medium 1506 and the memory 1505 may also be used for storing data that is manipulated by the processor 1504 when executing software.

One or more processors 1504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1506.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

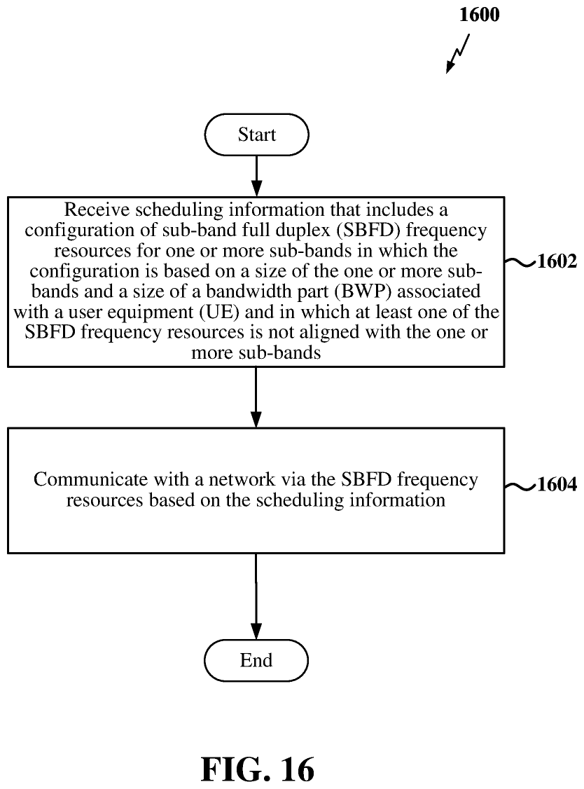

The UE 1500 may be configured to perform any one or more of the operations described herein (e.g., as described above in conjunction with FIGS. 7-14 and as described below in conjunction with FIG. 16). In some aspects of the disclosure, the processor 1504, as utilized in the UE 1500, may include circuitry configured for various functions.

In one aspect, the processor 1504 may include a communication and processing circuitry 1541. The communication and processing circuitry 1541 may include one or more hardware components that provide the physical structure that performs various processes related to wireless communication (e.g., signal reception and/or signal transmission) as described herein. The communication and processing circuitry 1541 may further include one or more hardware components that provide the physical structure that performs various processes related to signal processing (e.g., processing a received signal and/or processing a signal for transmission) as described herein. In some examples, the communication and processing circuitry 1541 may include two or more transmit/receive chains. The communication and processing circuitry 1541 may further be configured to execute communication and processing software 1551 included on the computer-readable medium 1506 to implement one or more functions described herein.

The processor 1504 also includes SBFD circuitry 1542 configured to implement various aspects disclosed herein. For instance, the SBFD circuitry 1542 may, in conjunction with communication and processing circuitry 1541 and/or the transceiver 1510, be configured to receive scheduling information that includes a configuration of SBFD frequency resources for one or more sub-bands in which the configuration is based on a size of the one or more sub-bands and a size of a BWP associated with the UE 1500 (e.g., where the BWP associated with the UE 1500 has a BWP size of at least 145 resource blocks), and in which at least one of the SBFD frequency resources is not aligned with the one or more sub-bands. The SBFD circuitry 1542 may, in conjunction with communication and processing circuitry 1541 and/or the transceiver 1510, be further configured to communicate with a network via the SBFD frequency resources based on the scheduling information. The SBFD circuitry 1542 may further be configured to execute SBFD instructions 1552 included on the computer-readable medium 1506 to implement one or more functions described herein.

In further aspects, the configuration of SBFD frequency resources may include at least two RBGs within each of the one or more sub-bands having a different RBG size. In such example, the SBFD circuitry 1542 may, in conjunction with communication and processing circuitry 1541 and/or the transceiver 1510, configure the UE 1500 to communicate with the network via the at least two RBGs. For instance, the at least two RBGs within each of the one or more sub-bands may include a first sub-band RBG and a last sub-band RBG, and wherein the RBG size of RBGs between the first sub-band RBG and the last sub-band RBG each have a different RBG size than the first sub-band RBG and the last sub-band RBG. In another example, the configuration of SBFD frequency resources includes having an RBG size of SBFD symbols be different than an RBG size of non-SBFD symbols.

In a further example, the configuration of SBFD frequency resources may include at least two PRGs within each of the one or more sub-bands having a different PRG size. In such example, the SBFD circuitry 1542 may, in conjunction with communication and processing circuitry 1541 and/or the transceiver 1510, configure the UE 1500 to communicate with the network via the at least two PRGs. For instance, the at least two PRGs within each of the one or more sub-bands may include a first sub-band PRG and a last sub-band PRG, and wherein the PRG size of the first sub-band PRG is different than the PRG size of the last sub-band PRG.

In another example, the SBFD circuitry 1542 may, in conjunction with communication and processing circuitry 1541 and/or the transceiver 1510, configure the UE 1500 to reference a first table for determining RBG sizes for an SBFD slot, and reference a second table for determining RBG sizes for a non-SBFD slot. Alternatively, the SBFD circuitry 1542 may, in conjunction with communication and processing circuitry 1541 and/or the transceiver 1510, configure the UE 1500 to reference a same table for determining RBG sizes for an SBFD slot and RBG sizes for a non-SBFD slot.

In yet another example, the scheduling information may further comprise an indication of a static bundling of PRG sizes in which the SBFD circuitry 1542 may, in conjunction with communication and processing circuitry 1541 and/or the transceiver 1510, configure the UE 1500 to determine PRG sizes based on a static bundling algorithm. Alternatively, the scheduling information may further comprise an indication of a dynamic bundling of PRG sizes in which the SBFD circuitry 1542 may, in conjunction with communication and processing circuitry 1541 and/or the transceiver 1510, configure the UE 1500 to determine PRG sizes based on a dynamic bundling algorithm.

In a further example, the configuration of SBFD frequency resources may include a number of bits allocated for an FDRA in an SBFD slot based on available resources in the SBFD slot in which the available resources in the SBFD slot are determined by an overlap of a corresponding sub-band of the one or more sub-bands and the BWP associated with the UE. In such example, the configuration of SBFD frequency resources may further include a configuration across multiple non-continuous sub-bands in which the available resources in the SBFD slot are determined by an overlap of the multiple non-continuous sub-bands and the BWP associated with the UE 1500. Alternatively, the configuration of SBFD frequency resources may include a configuration across a single sub-band, wherein the available resources in the SBFD slot are determined by an overlap of the single sub-band and the BWP associated with the UE 1500.

In yet another example, it is contemplated that the scheduling information may include a downlink control information (DCI) bitfield. For instance, the scheduling information may include at least one DCI bitfield indicating one or more sub-bands for data scheduling in an SBFD slot.

FIG. 16 is a flow chart illustrating an example wireless communication method 1600 implemented by a UE according to some aspects of the disclosure. As described herein, some or all illustrated features may be omitted in a particular implementation within the scope of the present disclosure, and some illustrated features may not be required for implementation of all examples. In some examples, the method 1600 may be carried out by the UE 1500 illustrated in FIG. 15. In some examples, the method 1600 may be carried out by any suitable apparatus or means for carrying out the functions or algorithm described below.

At block 1602, the UE may receive scheduling information that includes a configuration of SBFD frequency resources for one or more sub-bands in which the configuration is based on a size of the one or more sub-bands and a size of a BWP associated with the UE, and in which at least one of the SBFD frequency resources is not aligned with the one or more sub-bands. In an aspect, the processes of block 1602 may be implemented by a means for receiving the scheduling information, which may be implemented by processor 1504, communication and processing circuitry 1541, and/or transceiver 1510, in a particular aspect, or equivalents thereof.

Further at block 1604 the UE may configure the UE to communicate with a network via the SBFD frequency resources based on the scheduling information. In an aspect, the processes of block 1604 may be implemented by a means for communicating with a network, which may be implemented by processor 1504, communication and processing circuitry 1541, and/or SBFD circuitry 1542, in particular aspects, or equivalents thereof.

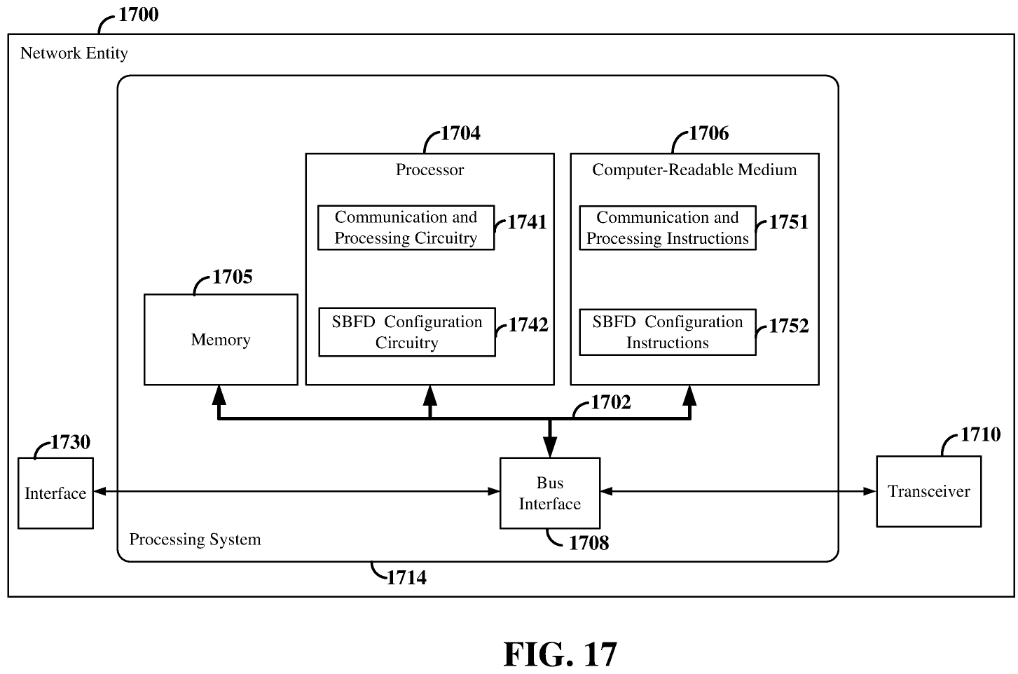

FIG. 17 is a block diagram conceptually illustrating an example of a hardware implementation for a network node or entity 1700 employing a processing system 1714 according to some aspects of the disclosure. In accordance with various aspects of the disclosure, an element, or any portion of an element, or any combination of elements may be implemented with a processing system 1714 that includes one or more processors 1704. In some implementations, the network entity 1700 may correspond to any of the BSs (e.g., gNBs, eNBs, etc.) or scheduling entities shown in any of the FIGs. included herein. In further aspects, the network entity 1700 may be configured as a base station operable within an Open RAN (O-RAN) environment, wherein the base station (e.g., 1700) is disaggregated and includes distinct parts including a distributed unit (DU), a centralized unit (CU), and a radio unit (RU). In yet further aspects, the disclosed and illustrated processing portions of network entity 1700 may be implemented within the RU, DU and/or the CU or within portions of each. In addition, the network entity 1600 may be a stationary network entity or a mobile network entity.

The network entity 1700 may be implemented with a processing system 1714 that includes one or more processors 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 1700 may be configured to perform any one or more of the functions described herein. That is, the processor 1704, as utilized in network entity 1700, may be used to implement any one or more of the processes and procedures described herein.

In this example, the processing system 1714 may be implemented with a bus architecture, represented generally by the bus 1702. The bus 1702 may include any number of interconnecting buses and bridges depending on the specific application of the processing system 1714 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further. A bus interface 1708 provides an interface between the bus 1702 and a transceiver 1710 and between the bus 1702 and an interface 1730. The transceiver 1710 provides a communication interface or means for communicating with various other apparatus over a wireless transmission medium. In some examples, the wireless communication device may include two or more transceivers 1710, each configured to communicate with a respective network type (e.g., terrestrial or non-terrestrial). At least one interface 1730 (e.g., a network interface and/or a user interface) provides a communication interface or means of communicating with various other apparatus and devices (e.g., other devices housed within the same apparatus as the network entity 1700 or an external apparatus) over an internal bus or external transmission medium, such as an Ethernet cable.

The processor 1704 is responsible for managing the bus 1702 and general processing, including the execution of software stored on the computer-readable medium 1706. The software, when executed by the processor 1704, causes the processing system 1714 to perform the various functions described below for any particular apparatus. The computer-readable medium 1706 and the memory 1705 may also be used for storing data that is manipulated by the processor 1704 when executing software.

One or more processors 1704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1706.

The computer-readable medium 1706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1706 may reside in the processing system 1714, external to the processing system 1714, or distributed across multiple entities including the processing system 1714. The computer-readable medium 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

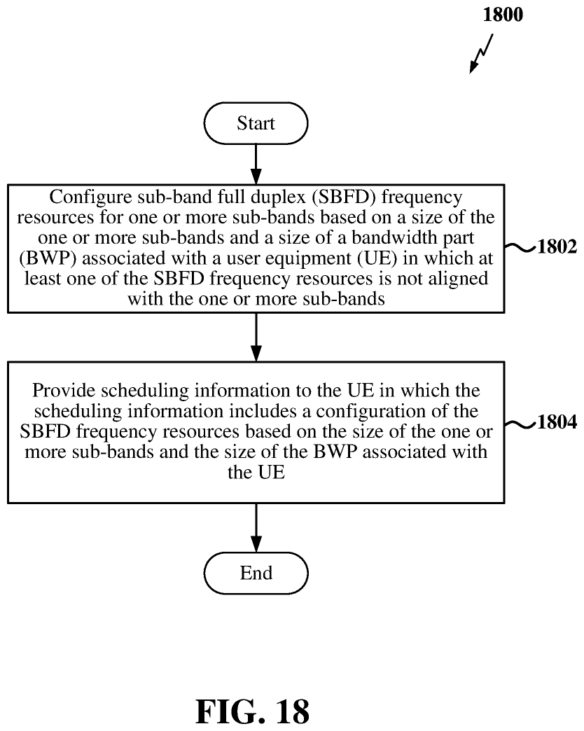

The network entity 1700 may be configured to perform any one or more of the operations described herein (e.g., as described above in conjunction with FIGS. 7-14 and as described below in conjunction with FIG. 18). In some aspects of the disclosure, the processor 1704, as utilized in the network entity 1700, may include circuitry configured for various functions.

The processor 1704 may be configured to generate, schedule, and modify a resource assignment or grant of time-frequency resources (e.g., a set of one or more resource elements). For example, the processor 1704 may schedule time-frequency resources within a plurality of time division duplex (TDD) and/or frequency division duplex (FDD) subframes, slots, and/or mini-slots to carry user data traffic and/or control information to and/or from multiple UEs.

The processor 1704 may be configured to schedule resources for the transmission of downlink reference signals (e.g., SSBs or CSI-RSs) or DCI (or SRS triggering) on a plurality of downlink beams for a downlink beam sweep in accordance with a selected downlink beam sweep type and selected number of downlink reference signal resources indicated in a request for uplink beam refinement received from a UE. The processor 1704 may further be configured to schedule resources for the uplink transmission of uplink reference signals (e.g., SRSs) on a plurality of uplink beams for an uplink beam sweep in accordance with a selected beam sweep type and selected number of uplink reference signal resources indicated in the request. The processor 1704 may further be configured to schedule resources that may be utilized by the UE to transmit the request. For example, the uplink beam refinement request resources may include resources scheduled for transmission of a PUCCH, PUSCH, PRACH occasion or RRC message. In some examples, the processor 1704 may be configured to schedule PUSCH resources for the uplink beam refinement request in response to receiving a scheduling request from the UE.

The processor 1704 may further be configured to schedule resources for the transmission of an uplink signal. In some examples, the resources may be associated with one or more uplink transmit beams and one or more corresponding receive beams applied to the uplink signal (e.g., based on the uplink BPLs) based on an indication of the uplink signal associated with the one or more uplink transmit beams included in the request. In some examples, the resources may be associated with an uplink transmission scheme indicating a number of uplink transmit beams to be utilized for the uplink signal, a number of repetitions per uplink transmit beam of the uplink signal, and a multiplexing scheme when more than one uplink transmit beam is used to transmit the uplink signal.

The processor 1704 may include communication and processing circuitry 1741. The communication and processing circuitry 1741 may include one or more hardware components that provide the physical structure that performs various processes related to wireless communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. In some examples, the communication and processing circuitry 1741 may include two or more transmit/receive chains. In another example, the communication and processing circuitry 1741 may be configured to communicate higher layer information such as RRC configuration information to a UE. The communication and processing circuitry 1741 may further be configured to execute communication and processing software 1751 included on the computer-readable medium 1706 to implement one or more functions described herein.

The processor 1704 also includes SBFD configuration circuitry 1742 configured to implement various aspects disclosed herein. For instance, the SBFD configuration circuitry 1742 may, in conjunction with communication and processing circuitry 1741 and/or the transceiver 1710, initiate or cause the network entity 1700 to configure SBFD frequency resources for one or more sub-bands based on a size of the one or more sub-bands and a size of a BWP associated with a UE (e.g., where a BWP associated with the UE has a BWP size of at least 145 resource blocks) in which at least one of the SBFD frequency resources is not aligned with the one or more sub-bands. The SBFD configuration circuitry 1742 may further, in conjunction with communication and processing circuitry 1741 and/or the transceiver 1710, initiate or cause the network entity 1700 to provide scheduling information to the UE in which the scheduling information includes a configuration of the SBFD frequency resources based on the size of the one or more sub-bands and the size of the BWP associated with the UE. The SBFD configuration circuitry 1742 may further be configured to execute SBFD configuration instructions 1752 included on the computer-readable medium 1706 to implement one or more functions described herein.

In further aspects, the SBFD frequency resources configured for the one or more sub-bands may include at least two RBGs within each of the one or more sub-bands having a different RBG size. In such example, the at least two RBGs within each of the one or more sub-bands may include a first sub-band RBG and a last sub-band RBG, and wherein the RBG size of RBGs between the first sub-band RBG and the last sub-band RBG each have a different RBG size than the first sub-band RBG and the last sub-band RBG. Processor 1704 may also be configured to configure the SBFD frequency resources so that an RBG size of SBFD symbols is different than an RBG size of non-SBFD symbols.

In a further example, the SBFD frequency resources configured for the one or more sub-bands may include at least two PRGs within each of the one or more sub-bands having a different PRG size. In such example, the at least two PRGs within each of the one or more sub-bands may include a first sub-band PRG and a last sub-band PRG in which the PRG size of the first sub-band PRG is different than the PRG size of the last sub-band PRG.

In another example, the SBFD configuration circuitry 1742 may, in conjunction with communication and processing circuitry 1741 and/or the transceiver 1710, initiate or cause the network entity 1700 to provide a configuration of the SBFD frequency resources that includes referencing a first table for determining RBG sizes for an SBFD slot, and referencing a second table for determining RBG sizes for a non-SBFD slot. Alternatively, the SBFD configuration circuitry 1742 may, in conjunction with communication and processing circuitry 1741 and/or the transceiver 1710, initiate or cause the network entity 1700 to provide a configuration of the SBFD frequency resources that includes referencing a same table for determining RBG sizes for an SBFD slot and RBG sizes for a non-SBFD slot.

In yet another example, the scheduling information further comprises an indication of a static bundling of PRG sizes to facilitate having a UE determine PRG sizes based on a static bundling algorithm. Alternatively, the scheduling information further comprises an indication of a dynamic bundling of PRG sizes to facilitate having a UE determine PRG sizes based on a dynamic bundling algorithm.

In a further example, the SBFD frequency resources configured for the one or more sub-bands may include a number of bits allocated for a FDRA in an SBFD slot based on available resources in the SBFD slot in which the available resources in the SBFD slot are determined by an overlap of a corresponding sub-band of the one or more sub-bands and the BWP associated with the UE. In such example, the SBFD frequency resources configured for the one or more sub-bands may include a configuration across multiple non-continuous sub-bands in which the available resources in the SBFD slot are determined by an overlap of the multiple non-continuous sub-bands and the BWP associated with the UE. Alternatively, the SBFD frequency resources configured for the one or more sub-bands may include a configuration across a single sub-band in which the available resources in the SBFD slot are determined by an overlap of the single sub-band and the BWP associated with the UE.

In another example, the scheduling information may further include at least one DCI bitfield indicating one or more sub-bands for data scheduling in an SBFD slot. In yet another example, the scheduling information may include at least one DCI bitfield indicating a dynamic switching between different configurations of an RBG granularity of the SBFD frequency resources.

FIG. 18 is a flow chart illustrating an example wireless communication method 1800 according to some aspects of the disclosure. As described herein, some or all illustrated features may be omitted in a particular implementation within the scope of the present disclosure, and some illustrated features may not be required for implementation of all examples. In some examples, the method 1800 may be carried out by the network entity 1700 (e.g., a gNB or base station including a base station operable in an O-RAN environment) illustrated in FIG. 17. In some examples, the method 1800 may be carried out by any suitable apparatus or means for carrying out the functions or algorithm described below.

At block 1802, the method 1800 includes configuring SBFD frequency resources for one or more sub-bands based on a size of the one or more sub-bands and a size of a BWP associated with a UE in which at least one of the SBFD frequency resources is not aligned with the one or more sub-bands. In an aspect, the processes of block 1802 may implemented by a means for configuring SBFD frequency resources, which may be implemented by processor 1704 and SBFD configuration circuitry 1742, in a particular aspect, or equivalents thereof.

Additionally, in block 1804, method 1800 includes providing scheduling information to the UE in which the scheduling information includes a configuration of the SBFD frequency resources based on the size of the one or more sub-bands and the size of the BWP associated with the UE. In an aspect, the processes of block 1804 may implemented by a means for providing scheduling information, which may be implemented by processor 1704, communication and processing circuitry 1741 and transceiver 1710, in a particular aspect, or equivalents thereof.

Of further note, the present disclosure may include the following further aspects of the present disclosure.

Aspect 1: A network entity configured for wireless communication comprising a memory and a processor coupled to the memory, the processor being configured to: configure SBFD frequency resources for one or more sub-bands based on a size of the one or more sub-bands and a size of a BWP associated with a UE, and wherein at least one of the SBFD frequency resources is not aligned with the one or more sub-bands; and provide scheduling information to the UE, wherein the scheduling information includes a configuration of the SBFD frequency resources based on the size of the one or more sub-bands and the size of the BWP associated with the UE.

Aspect 2: The network entity of aspect 1, wherein the SBFD frequency resources configured for the one or more sub-bands includes at least two RBGs within each of the one or more sub-bands having a different RBG size.

Aspect 3: The network entity of aspect 2, wherein the at least two RBGs within each of the one or more sub-bands include a first sub-band RBG and a last sub-band RBG, and wherein the RBG size of RBGs between the first sub-band RBG and the last sub-band RBG each have a different RBG size than the first sub-band RBG and the last sub-band RBG.

Aspect 4: The network entity of any of aspects 1 through 3, wherein the processor is configured to configure the SBFD frequency resources so that an RBG size of SBFD symbols is different than an RBG size of non-SBFD symbols.

Aspect 5: The network entity of any of aspects 1 through 4, wherein the SBFD frequency resources configured for the one or more sub-bands includes at least two PRGs within each of the one or more sub-bands having a different PRG size.

Aspect 6: The network entity of aspect 5, wherein the at least two PRGs within each of the one or more sub-bands include a first sub-band PRG and a last sub-band PRG, and wherein the PRG size of the first sub-band PRG is different than the PRG size of the last sub-band PRG.

Aspect 7: The network entity of any of aspects 1 through 6, wherein the SBFD frequency resources configured for the one or more sub-bands includes a number of bits allocated for an FDRA in an SBFD slot based on available resources in the SBFD slot, and wherein the available resources in the SBFD slot are determined by an overlap of a corresponding sub-band of the one or more sub-bands and the BWP associated with the UE.

Aspect 8: The network entity of aspect 7, wherein the SBFD frequency resources configured for the one or more sub-bands includes a configuration across a single sub-band, and wherein the available resources in the SBFD slot are determined by an overlap of the single sub-band and the BWP associated with the UE.

Aspect 9: The network entity of aspect 7, wherein the SBFD frequency resources configured for the one or more sub-bands includes a configuration across multiple non-continuous sub-bands, and wherein the available resources in the SBFD slot are determined by an overlap of the multiple non-continuous sub-bands and the BWP associated with the UE.

Aspect 10: The network entity of any of aspects 1 through 9, wherein the scheduling information includes at least one DCI bitfield indicating one or more sub-bands for data scheduling in an SBFD slot.

Aspect 11: A method for wireless communications in a network entity comprising: configuring SBFD frequency resources for one or more sub-bands based on a size of the one or more sub-bands and a size of a BWP associated with a UE, and wherein at least one of the SBFD frequency resources is not aligned with the one or more sub-bands; and providing scheduling information to the UE, wherein the scheduling information includes a configuration of the SBFD frequency resources based on the size of the one or more sub-bands and the size of the BWP associated with the UE.

Aspect 12: The method of aspect 11, wherein the configuration of the SBFD frequency resources includes: referencing a first table for determining RBG sizes for an SBFD slot; and referencing a second table for determining RBG sizes for a non-SBFD slot.

Aspect 13: The method of aspect 11, wherein the configuration of the SBFD frequency resources includes referencing a same table for determining RBG sizes for an SBFD slot and RBG sizes for a non-SBFD slot.

Aspect 14: The method of any of aspects 11 through 13, wherein the scheduling information further comprises an indication of a static bundling of PRG sizes.

Aspect 15: The method of any of aspects 11 through 14, wherein the scheduling information further comprises an indication of a dynamic bundling of PRG sizes.

Aspect 16: A UE, comprising a transceiver, a memory, and a processor coupled to the transceiver and the memory, wherein the processor is configured to: receive scheduling information that includes a configuration of SBFD frequency resources for one or more sub-bands, wherein the configuration is based on a size of the one or more sub-bands and a size of a BWP associated with the UE, and wherein at least one of the SBFD frequency resources is not aligned with the one or more sub-bands; and communicate with a network via the SBFD frequency resources based on the scheduling information.

Aspect 17: The UE of aspect 16, wherein the configuration of SBFD frequency resources includes at least two RBGs within each of the one or more sub-bands having a different RBG size, and wherein the processor is further configured to configure the UE to communicate with the network via the at least two RBGs.

Aspect 18: The UE of aspect 17, wherein the at least two RBGs within each of the one or more sub-bands include a first sub-band RBG and a last sub-band RBG, and wherein the RBG size of RBGs between the first sub-band RBG and the last sub-band RBG each have a different RBG size than the first sub-band RBG and the last sub-band RBG.

Aspect 19: The UE of any of aspects 16 through 18, wherein the configuration of SBFD frequency resources includes at least two PRGs within each of the one or more sub-bands having a different PRG size, and wherein the processor is further configured to configure the UE to communicate with the network via the at least two PRGs.

Aspect 20: The UE of aspect 19, wherein the at least two PRGs within each of the one or more sub-bands include a first sub-band PRG and a last sub-band PRG, and wherein the PRG size of the first sub-band PRG is different than the PRG size of the last sub-band PRG.

Aspect 21: The UE of any of aspects 16 through 20, wherein the configuration of SBFD frequency resources includes a number of bits allocated for an FDRA in an SBFD slot based on available resources in the SBFD slot, and wherein the available resources in the SBFD slot are determined by an overlap of a corresponding sub-band of the one or more sub-bands and the BWP associated with the UE.

Aspect 22: The UE of aspect 21, wherein the configuration of SBFD frequency resources includes a configuration across a single sub-band, and wherein the available resources in the SBFD slot are determined by an overlap of the single sub-band and the BWP associated with the UE.

Aspect 23: The UE of aspect 21, wherein the configuration of SBFD frequency resources includes a configuration across multiple non-continuous sub-bands, and wherein the available resources in the SBFD slot are determined by an overlap of the multiple non-continuous sub-bands and the BWP associated with the UE.

Aspect 24: The UE of any of aspects 16 through 23, wherein the scheduling information includes at least one downlink control information (DCI) bitfield indicating one or more sub-bands for data scheduling in an SBFD slot.

Aspect 25: A method for wireless communication in a UE, comprising: receiving scheduling information that includes a configuration of SBFD frequency resources for one or more sub-bands, wherein the configuration is based on a size of the one or more sub-bands and a size of a BWP associated with the UE, and wherein at least one of the SBFD frequency resources is not aligned with the one or more sub-bands; and communicating with a network via the SBFD frequency resources based on the scheduling information.

Aspect 26: The method of aspect 25, wherein the configuration of SBFD frequency resources includes having an RBG size of SBFD symbols be different than an RBG size of non-SBFD symbols.

Aspect 27: The method of any of aspects 25 through 26, wherein the configuring comprises: referencing a first table for determining RBG sizes for an SBFD slot; and referencing a second table for determining RBG sizes for a non-SBFD slot.

Aspect 28: The method of any of aspects 25 through 26, wherein the configuring comprises referencing a same table for determining RBG sizes for an SBFD slot and RBG sizes for a non-SBFD slot.

Aspect 29: The method of any of aspects 25 through 28, wherein the scheduling information further comprises an indication of a static bundling of PRG sizes, and wherein the configuring comprises determining PRG sizes based on a static bundling algorithm.

Aspect 30: The method of any of aspects 25 through 29, wherein the scheduling information further comprises an indication of a dynamic bundling of PRG sizes, and wherein the configuring comprises determining PRG sizes based on a dynamic bundling algorithm.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) standards IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may encompass a wide variety of actions. For example, “determining” may include calculating, computing, processing, deriving, investigating, looking up (e.g., looking up in a table, a database or another data structure), ascertaining, resolving, selecting, choosing, establishing, receiving (e.g., receiving information), accessing (e.g., accessing data in a memory), and the like.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in any of FIGS. 1-18 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A network entity configured for wireless communication, comprising:
a memory; and
a processor coupled to the memory, the processor being configured to:
configure sub-band full duplex (SBFD) frequency resources for one or more sub-bands based on a size of the one or more sub-bands and a size of a bandwidth part (BWP) associated with a user equipment (UE), and wherein at least one of the SBFD frequency resources is not aligned with the one or more sub-bands; and
provide scheduling information to the UE, wherein the scheduling information includes a configuration of the SBFD frequency resources based on the size of the one or more sub-bands and the size of the BWP associated with the UE.

2. The network entity of claim 1, wherein the SBFD frequency resources configured for the one or more sub-bands includes at least two resource block groups (RBGs) within each of the one or more sub-bands having a different RBG size.

3. The network entity of claim 2, wherein the at least two RBGs within each of the one or more sub-bands include a first sub-band RBG and a last sub-band RBG, and wherein the RBG size of RBGs between the first sub-band RBG and the last sub-band RBG each have a different RBG size than the first sub-band RBG and the last sub-band RBG.

4. The network entity of claim 1, wherein the processor is configured to configure the SBFD frequency resources so that a resource block group (RBG) size of SBFD symbols is different than an RBG size of non-SBFD symbols.

5. The network entity of claim 1, wherein the SBFD frequency resources configured for the one or more sub-bands includes at least two precoding resource block groups (PRGs) within each of the one or more sub-bands having a different PRG size.

6. The network entity of claim 5, wherein the at least two PRGs within each of the one or more sub-bands include a first sub-band PRG and a last sub-band PRG, and wherein the PRG size of the first sub-band PRG is different than the PRG size of the last sub-band PRG.

7. The network entity of claim 1, wherein the SBFD frequency resources configured for the one or more sub-bands includes a number of bits allocated for a frequency domain resource assignment (FDRA) in an SBFD slot based on available resources in the SBFD slot, and wherein the available resources in the SBFD slot are determined by an overlap of a corresponding sub-band of the one or more sub-bands and the BWP associated with the UE.

8. The network entity of claim 7, wherein the SBFD frequency resources configured for the one or more sub-bands includes a configuration across a single sub-band, and wherein the available resources in the SBFD slot are determined by an overlap of the single sub-band and the BWP associated with the UE.

9. The network entity of claim 7, wherein the SBFD frequency resources configured for the one or more sub-bands includes a configuration across multiple non-continuous sub-bands, and wherein the available resources in the SBFD slot are determined by an overlap of the multiple non-continuous sub-bands and the BWP associated with the UE.

10. The network entity of claim 1, wherein the scheduling information includes at least one downlink control information (DCI) bitfield indicating one or more sub-bands for data scheduling in an SBFD slot.

11. A method for wireless communications in a network entity comprising:
configuring sub-band full duplex (SBFD) frequency resources for one or more sub-bands based on a size of the one or more sub-bands and a size of a bandwidth part (BWP) associated with a user equipment (UE), and wherein at least one of the SBFD frequency resources is not aligned with the one or more sub-bands; and
providing scheduling information to the UE, wherein the scheduling information includes a configuration of the SBFD frequency resources based on the size of the one or more sub-bands and the size of the BWP associated with the UE.

12. The method of claim 11, wherein the configuration of the SBFD resources includes:
referencing a first table for determining resource block group (RBG) sizes for an SBFD slot; and
referencing a second table for determining RBG sizes for a non-SBFD slot.

13. The method of claim 11, wherein the configuration of the SBFD resources includes referencing a same table for determining resource block group (RBG) sizes for an SBFD slot and RBG sizes for a non-SBFD slot.

14. The method of claim 11, wherein the scheduling information further comprises an indication of a static bundling of precoding resource block group (PRG) sizes.

15. The method of claim 11, wherein the scheduling information further comprises an indication of a dynamic bundling of precoding resource block group (PRG) sizes.

16. A user equipment (UE), comprising:
a transceiver;
a memory; and
a processor coupled to the transceiver and the memory, wherein the processor is configured to:
receive scheduling information that includes a configuration of sub-band full duplex (SBFD) frequency resources for one or more sub-bands, wherein the configuration is based on a size of the one or more sub-bands and a size of a bandwidth part (BWP) associated with the UE, and wherein at least one of the SBFD frequency resources is not aligned with the one or more sub-bands; and
communicate with a network via the SBFD frequency resources based on the scheduling information.

17. The UE of claim 16, wherein the configuration of SBFD frequency resources includes at least two resource block groups (RBGs) within each of the one or more sub-bands having a different RBG size, and wherein the processor is further configured to configure the UE to communicate with the network via the at least two RBGs.

18. The UE of claim 17, wherein the at least two RBGs within each of the one or more sub-bands include a first sub-band RBG and a last sub-band RBG, and wherein the RBG size of RBGs between the first sub-band RBG and the last sub-band RBG each have a different RBG size than the first sub-band RBG and the last sub-band RBG.

19. The UE of claim 16, wherein the configuration of SBFD frequency resources includes at least two precoding resource block groups (PRGs) within each of the one or more sub-bands having a different PRG size, and wherein the processor is further configured to configure the UE to communicate with the network via the at least two PRGs.

20. The UE of claim 19, wherein the at least two PRGs within each of the one or more sub-bands include a first sub-band PRG and a last sub-band PRG, and wherein the PRG size of the first sub-band PRG is different than the PRG size of the last sub-band PRG.

21. The UE of claim 16, wherein the configuration of SBFD frequency resources includes a number of bits allocated for a frequency domain resource assignment (FDRA) in an SBFD slot based on available resources in the SBFD slot, and wherein the available resources in the SBFD slot are determined by an overlap of a corresponding sub-band of the one or more sub-bands and the BWP associated with the UE.

22. The UE of claim 21, wherein the configuration of SBFD frequency resources includes a configuration across a single sub-band, and wherein the available resources in the SBFD slot are determined by an overlap of the single sub-band and the BWP associated with the UE.

23. The UE of claim 21, wherein the configuration of SBFD frequency resources includes a configuration across multiple non-continuous sub-bands, and wherein the available resources in the SBFD slot are determined by an overlap of the multiple non-continuous sub-bands and the BWP associated with the UE.

24. The UE of claim 16, wherein the scheduling information includes at least one downlink control information (DCI) bitfield indicating one or more sub-bands for data scheduling in an SBFD slot.

25. A method for wireless communications in a user equipment (UE) comprising:
receiving scheduling information that includes a configuration of sub-band full duplex (SBFD) frequency resources for one or more sub-bands, wherein the configuration is based on a size of the one or more sub-bands and a size of a bandwidth part (BWP) associated with the UE, and wherein at least one of the SBFD frequency resources is not aligned with the one or more sub-bands; and
communicating with a network via the SBFD frequency resources based on the scheduling information.

26. The method of claim 25, wherein the configuration of SBFD frequency resources includes having a resource block group (RBG) size of SBFD symbols be different than an RBG size of non-SBFD symbols.

27. The method of claim 25, wherein the configuring comprises:
referencing a first table for determining resource block group (RBG) sizes for an SBFD slot; and
referencing a second table for determining RBG sizes for a non-SBFD slot.

28. The method of claim 25, wherein the configuring comprises referencing a same table for determining resource block group (RBG) sizes for an SBFD slot and RBG sizes for a non-SBFD slot.

29. The method of claim 25, wherein the scheduling information further comprises an indication of a static bundling of precoding resource block group (PRG) sizes, and wherein the configuring comprises determining PRG sizes based on a static bundling algorithm.

30. The method of claim 25, wherein the scheduling information further comprises an indication of a dynamic bundling of precoding resource block group (PRG) sizes, and wherein the configuring comprises determining PRG sizes based on a dynamic bundling algorithm.
